(19) United States
(12) Patent Application Publication
(10) Pub. No.: US 2017/0072945 A1
(43) Pub. Date: Mar. 16, 2017

(54) SYSTEM AND METHOD FOR CONTROLLING SWITCHING BETWEEN DRIVING MODES OF HYBRID ELECTRIC VEHICLE

(71) Applicant: Hyundai Motor Company, Seoul (KR)

(72) Inventor: Joon Young Park, Seoul (KR)

(21) Appl. No.: 15/201,058

(22) Filed: Jul. 1, 2016

(30) Foreign Application Priority Data
Sep. 10, 2015 (KR) 10-2015-0128184

(51) Int. Cl. B60W 20/40; F02D 41/26; F02D 41/30; B60W 10/06; B60W 10/08

(52) U.S. Cl. CPC B60W 20/40; B60W 10/06; B60W 10/08; F02D 41/3005; F02D 41/26; B60W 2510/1005; B60W 2510/06; Y10S 903/93; B60W 2710/083; B60W 2710/0616

(57) ABSTRACT

A system and method for controlling switching between driving modes of a hybrid electric vehicle are provided. In particular, driving mode switching is performed from an electric vehicle (EV) mode to a hybrid electric vehicle (HEV) mode under a condition in which the fuel injection compensation amount when an engine is first started is minimized The driving mode switching from an EV mode to an HEV mode is performed before gear shift from a lower gear to a higher gear is completed (e.g., before the speed of a motor is reduced) during accelerated driving of the vehicle to minimize the fuel injection compensation amount when an engine is first started, thereby improving fuel efficiency.

### CROSS-REFERENCE TO RELATED APPLICATION

This application claims under 35 U.S.C. §119(a) the benefit of priority to Korean Patent Application No. 10-2015-0128184 filed on Sep. 10, 2015, the entire contents of which are incorporated herein by reference.

### BACKGROUND

(a) Technical Field

The present disclosure relates to a system and method for controlling switching between driving modes of a hybrid electric vehicle, and more particularly, to a system and method for controlling switching between driving modes of a hybrid electric vehicle that are capable of performing driving mode switching from an electric vehicle (EV) mode to a hybrid electric vehicle (HEV) mode under a condition in which the fuel injection compensation amount when an engine is first started is minimized.

(b) Background Art

As shown in FIG. 1, an example of a powertrain system for hybrid electric vehicles of the related art includes an engine 10 and a motor 12, which are disposed in series, an engine clutch 13 disposed between the engine 10 and the motor 12 configured to transmit or interrupt engine power, a transmission 14 configured to output motor power or motor and engine power to driving wheels while performing gear shift, an integrated starter-generator (ISG) 11, which is a type of motor, connected to a crank pulley of the engine to allow power to be transmitted for starting the engine and generating electric power to charge a battery, an inverter configured to perform motor control and power generation control, and a high-voltage battery connected to an inverter in a chargeable and dischargeable fashion to provide electric power to the motor.

The powertrain system for hybrid electric vehicles, in which the motor is connected to the automatic transmission, is referred to as a transmission mounted electric device (TMED) type system, which provides various driving modes, such as an electric vehicle (EV) mode, which is a pure electric vehicle mode using motor power, a hybrid electric vehicle (HEV) mode, which uses the engine as main power and the motor as auxiliary power, and a regenerative braking (RB) mode, in which braking and inertia energy of the vehicle is collected using power generation from the motor to charge the battery.

Meanwhile, as shown in FIG. 2, driving mode switching from the EV mode to the HEV mode by the powertrain system for hybrid electric vehicles includes starting the engine, synchronizing the engine speed with the motor speed, and locking the engine clutch after synchronization. To prevent misfire of the engine when starting the engine, additional fuel injection compensation control is performed based on the engine speed, coolant temperature, etc. The lower the engine speed or the coolant temperature is, the greater the fuel injection compensation amount is.

When the additional fuel injection compensation control is performed, as shown in FIG. 3, actual torque is greater than engine reference torque, with the result that fuel is excessively consumed. In addition, when the motor speed is low during driving mode switching from the EV mode to the HEV mode, the initial fuel injection compensation amount is excessively large, with the result that fuel efficiency is decreased. The reasons are as follows.

As shown in the upper graph of FIG. 4A, when the motor speed is high after the engine starting, fuel injection into the engine is performed to increase the engine speed to synchronize the engine speed with the motor speed, and additional fuel injection compensation is performed to prevent misfire of the engine at a specific high revolutions per minute (RPM) (fuel injection compensation start RPM) of the engine. In particular, as shown in the lower graph of FIG. 4A, the additional fuel injection compensation amount is appropriate, with the result that fuel consumption is low. The engine speed has already been increased to a specific high RPM (fuel injection compensation start RPM) of the engine immediately before the engine speed is synchronized with the motor speed, which is high, and thus a possibility of engine misfiring is decreased.

Furthermore, as shown in the upper graph of FIG. 4B, when the motor speed is low after the engine starting, fuel injection into the engine is performed to increase the engine speed to synchronize the engine speed with the motor speed, and additional fuel injection compensation is performed to prevent misfire of the engine at a specific low RPM (fuel injection compensation start RPM) of the engine. Particularly, as shown in the lower graph of FIG. 4B, the additional fuel injection compensation amount is excessive, with the result that fuel consumption is high. The engine speed has already been increased to a specific low RPM (fuel injection compensation start RPM) of the engine immediately before the engine speed is synchronized with the motor speed, which is low, and thus a possibility of engine misfiring is increases. In other words, when the motor speed is low during driving mode switching from the EV mode to the HEV mode, the fuel injection compensation amount is excessive, and thus fuel efficiency is reduced.

### SUMMARY

The present invention provides a system and method for controlling switching between driving modes of a hybrid electric vehicle that are capable of performing driving mode switching from an EV mode to an HEV mode before gear shift from a lower gear to a higher gear is completed (e.g., before the speed of a motor is reduced) during accelerated driving of the vehicle to minimize the fuel injection compensation amount when an engine is first started, thereby improving fuel efficiency.

In one aspect, the present invention provides a system for controlling switching between driving modes of a hybrid electric vehicle comprising an engine, a motor connected to an input shaft of a transmission, and a clutch disposed between the engine and the motor to execute an EV mode and an HEV mode, the system may include a gear shift prediction unit configured to predict gear shift from a lower gear to a higher gear and a driving mode switching controller configured to reduce a switching reference value for driving mode switching from the EV mode to the HEV mode as a result of the gear shift prediction unit predicting that the gear shift is being performed from the lower gear to the higher gear.

In another aspect, the present invention provides a method of controlling switching between driving modes of a hybrid electric vehicle, that may include predicting gear shift from a lower gear to a higher gear, reducing a switching reference value for driving mode switching from an EV mode to an HEV mode to an arbitrary level as a result of predicting the gear shift from the lower gear to the higher gear, and performing fuel injection compensation control at a specific RPM of the engine before the gear shift from the lower gear to the higher gear is completed during the driving mode switching from the EV mode to the HEV mode.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a view showing a powertrain system of a hybrid electric vehicle according to the related art;

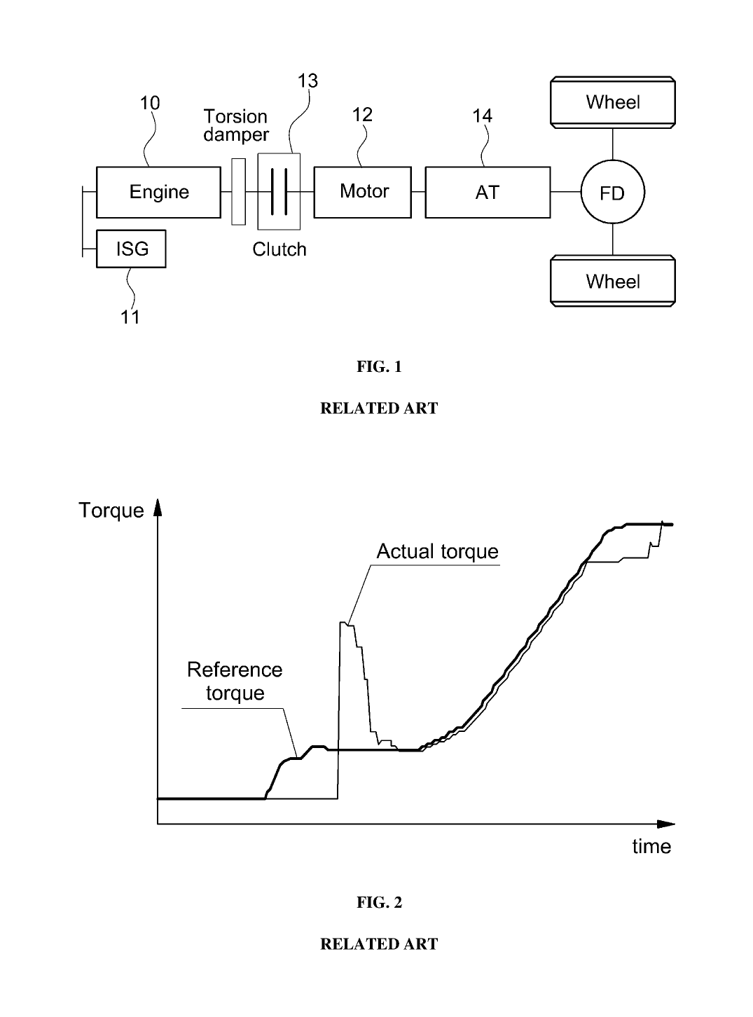

FIG. 2 is a graph showing a driving mode switching process from an EV mode to an HEV mode of the hybrid electric vehicle according to the related art;

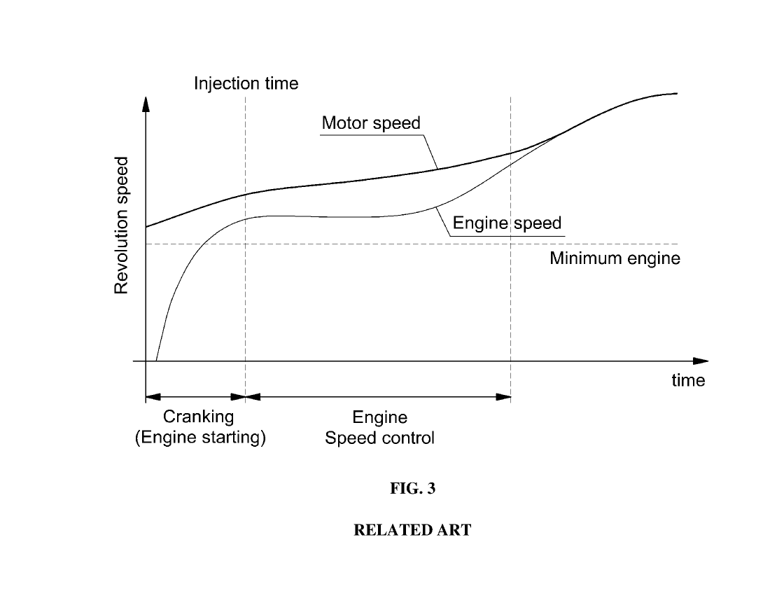

FIG. 3 is a graph showing a comparison between engine reference torque and actual torque during additional fuel injection compensation according to the related art;

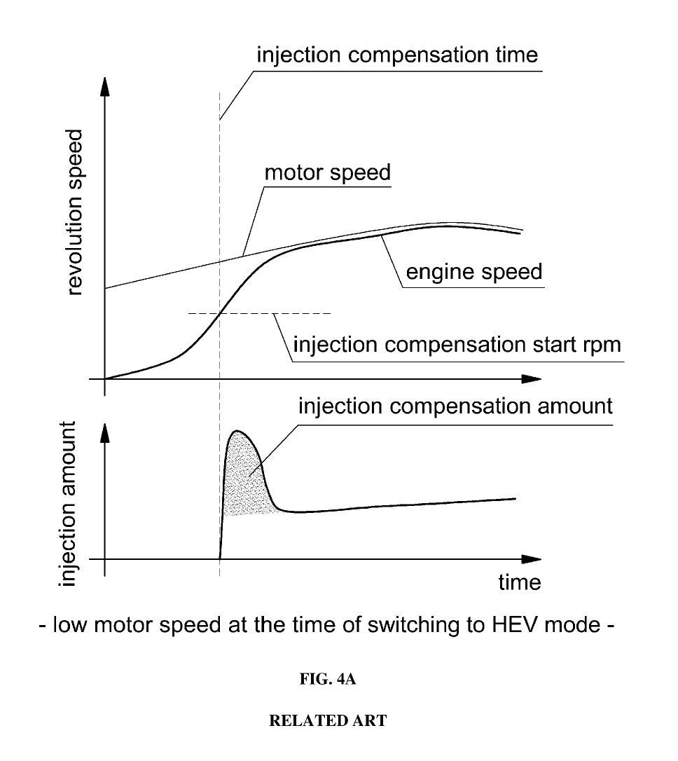

FIG. 4A is a graph showing an injection compensation control process when the speed of a motor is high when switching from the EV mode to the HEV mode according to the related art;

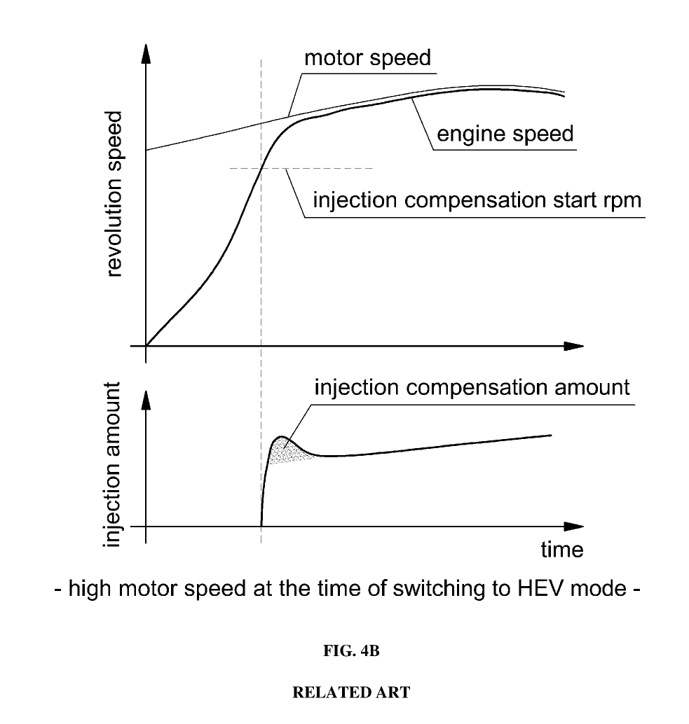

FIG. 4B is a graph showing a fuel injection compensation control process when the speed of a motor is low when switching from the EV mode to the HEV mode according to the related art;

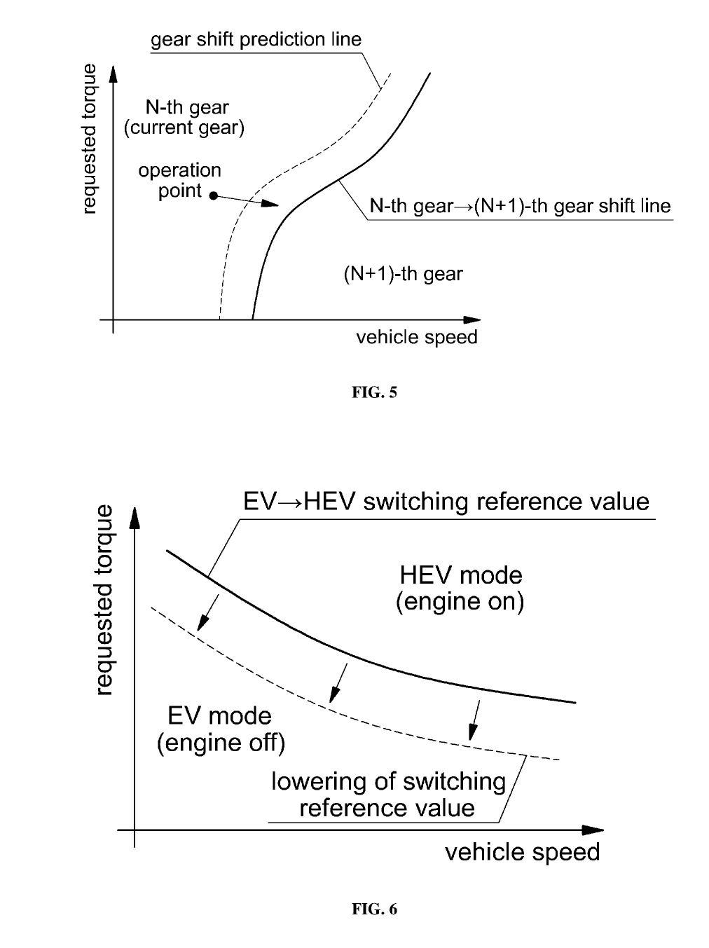

FIGS. 5 and 6 are graphs showing a process of controlling switching between driving modes of a hybrid electric vehicle according to an exemplary embodiment of the present invention;

FIGS. 7A-7B illustrate a comparison between a conventional fuel injection compensation control process and a fuel injection compensation control process according to an exemplary embodiment of the present invention; and

FIG. 8 illustrates the process of controlling switching between driving modes of the hybrid electric vehicle according to an exemplary embodiment of the present invention.

It should be understood that the appended drawings are not necessarily to scale, presenting a somewhat simplified representation of exemplary preferred features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

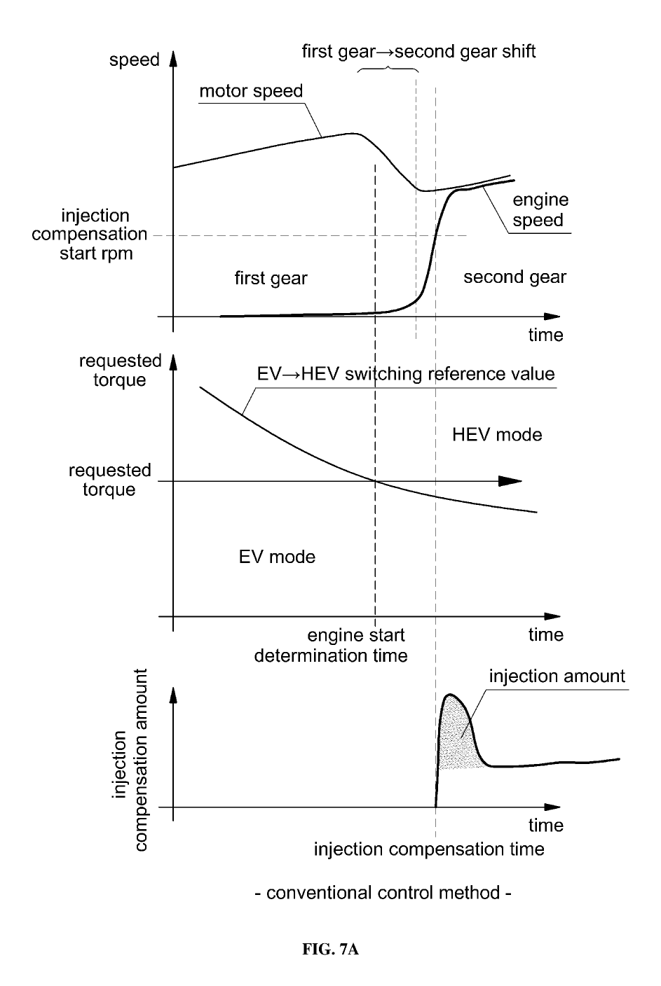

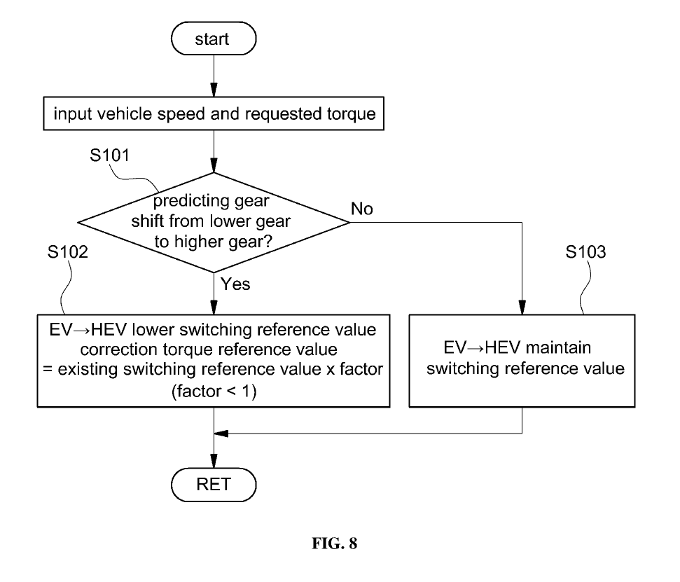

The present invention is characterized in that switching from an EV mode to an HEV mode may be performed before gear shift from a lower gear to a higher gear of a hybrid electric vehicle is completed (e.g., before the speed of a motor is reduced) during accelerated driving of the vehicle, thereby improving fuel efficiency. FIGS. 5 and 6 are graphs showing a process of controlling switching between driving modes of a hybrid electric vehicle according to an exemplary embodiment of the present invention, and FIG. 8 illustrates the process of controlling switching between driving modes of the hybrid electric vehicle according to an exemplary embodiment of the present invention.

First, a gear shift prediction unit may be configured to predict gear shift from a lower gear to a higher gear during accelerated driving of the vehicle (S101). The gear shift prediction unit may be a sensor operated by a controller. The gear shift prediction unit may be constituted by additionally setting a gear shift prediction line in a gear shift map of a transmission controller (TCU). Further, the gear shift prediction unit may be configured to predict gear shift between a start time of an engine and a time when an engine clutch is completely locked before gear shift from a current gear to a higher gear is completed.

Accordingly, as shown in FIG. 5, a gear shift prediction line may be additionally set in a gear shift map of the transmission controller including torque requested by a driver and a vehicle speed. Specifically, the gear shift prediction line may be additionally set before an actual gear shift line (N-th gear->(N+1)-th gear) in which gear shifting is performed from a lower gear (N-th gear) to a higher gear ((N+1)-th gear). Consequently, the gear shift prediction unit may be configured to determine that a current driving operation point of the vehicle is a point after the gear shift prediction line and before the actual gear shift line, and predict that gear shift is being performed from the lower gear (N-th gear) to the higher gear ((N+1)-th gear).

The gear shift prediction unit may be configured to predict gear shift from the lower gear to the higher gear since the speed of the motor is reduced, as previously described, after the gear shift is completed, with the result that the fuel injection compensation amount is excessively increased. Thus, fuel injection compensation control may be performed before the gear shift from the lower gear (N-th gear) to the higher gear ((N+1)-th gear) is completed (before the speed of the motor is reduced). Subsequently, when the gear shift prediction unit predicts that the gear shift is being performed from the lower gear (N-th gear) to the higher gear ((N+1)-th gear), a driving mode switching controller may be configured to reduce a switching reference value for driving mode switching from the EV mode to the HEV mode (S102).

For example, when the gear shift prediction unit predicts that the gear shift is being performed from the lower gear (N-th gear) to the higher gear ((N+1)-th gear) and transmits a prediction signal to a hybrid controller (HCU), which is the highest-level controller of the hybrid electric vehicle, as shown in FIG. 6, the hybrid controller may be configured to decrease the switching reference value (e.g., torque requested by the driver) for driving mode switching from the EV mode to the HEV mode to an arbitrary level. The decrease of the switching reference value for driving mode switching from the EV mode to the HEV mode may be defined as decreasing the torque requested by the driver to an arbitrary level, and the switching reference value (e.g., the torque requested by the driver) decreased to the arbitrary level may be set as a correction torque reference value.

Further, a second switching reference value that is less than the existing switching reference value (e.g., the switching reference value before decrease or the first switching reference value) may be set, or a factor less than 1 (factor<1) may be applied to the first switching reference value, as shown in Equation 1 below, to decrease the switching reference value to the correction torque reference value.

Correction torque reference value=existing switching reference value×factor (factor<1) Equation 1

When the existing switching reference value for driving mode switching from the EV mode to the HEV mode is decreased to the correction torque reference value, a start time of the engine based on the torque requested by the driver becomes earlier, thereby rapidly achieving driving mode switching from the EV mode to the HEV mode. In addition to the driving mode switching from the EV mode to the HEV mode, an engine controller may be configured to perform fuel injection compensation control at a specific RPM of the engine before gear shifting from a lower gear to a higher gear is completed (e.g., before the speed of the motor is reduced). At this time, the fuel injection compensation amount may be adjusted to be substantially reduced. In addition, the fuel injection compensation control may be performed such that the fuel injection compensation amount at the lower gear is less than that at the higher gear.

Furthermore, as shown in FIG. 8, when the gear shift prediction unit does not predict the gear shift from the lower gear to the higher gear, the driving mode switching controller may be configured to maintain the switching reference value for driving mode switching from the EV mode to the HEV mode at the existing (e.g., the first) switching reference value (the switching reference value before decrease) (S103).

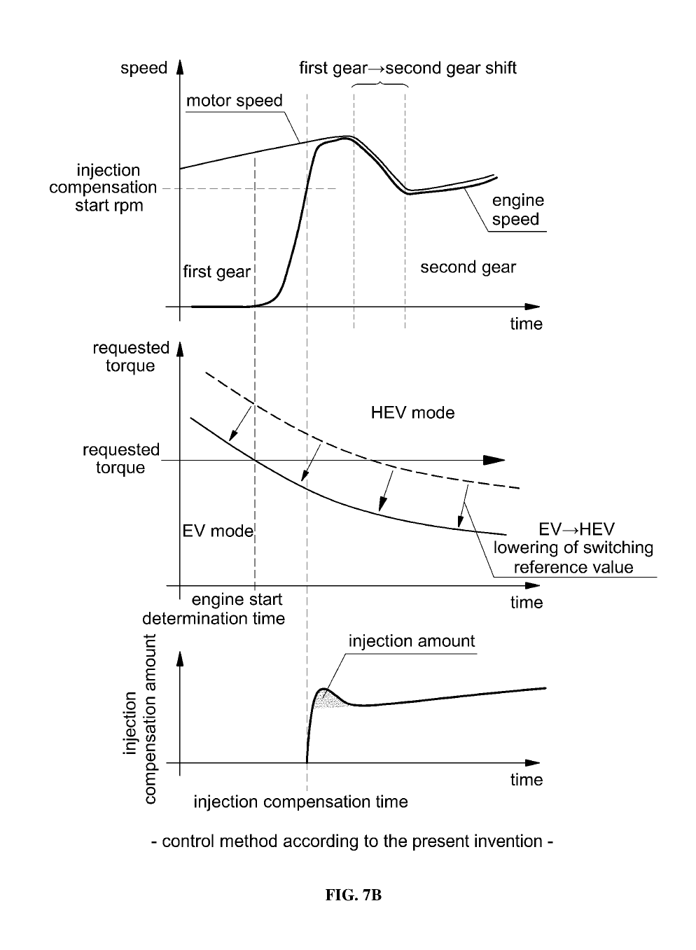

Referring to FIGS. 7A-7B, which show a comparison between a conventional fuel injection compensation control process and a fuel injection compensation control process according to an exemplary embodiment of the present invention, when the gear shift prediction unit predicts that the gear shift is being performed from a lower gear (e.g. a first gear) to a higher gear (e.g. a second gear), the driving mode switching controller may be configured to execute the driving mode switching from the EV mode to the HEV mode before the gear shift from the lower gear to the higher gear is completed (e.g., before the speed of the motor is reduced), and accordingly it may be possible to more rapidly inject fuel into the engine than in the conventional fuel injection compensation control process, with the result that the speed of the engine may be increased to be synchronized with the speed of the motor.

In particular, as shown in FIGS. 7A-7B, the driving mode switching from the EV mode to the HEV mode may be performed before the speed of the motor is reduced, and the fuel injection compensation amount at the specific RPM of the engine is less than that in the conventional fuel injection compensation control process, thereby minimizing fuel consumption due to excessive fuel injection compensation at the low speed of the motor in the conventional fuel injection compensation control process, and improving fuel efficiency.

As is apparent from the above description, the present invention has the following effect.

According to the present invention, the driving mode switching from the EV mode to the HEV mode may be performed before the gear shift from the lower gear to the higher gear is completed (before the speed of the motor is reduced), and then the fuel injection compensation control may be performed before the speed of the motor is reduced, thereby minimizing fuel consumption due to excessive fuel injection compensation at the low speed of the motor in the conventional fuel injection compensation control process, and improving fuel efficiency.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A system for controlling switching between driving modes of a hybrid electric vehicle HEV) comprising an engine, a motor connected to an input shaft of a transmission, and a clutch disposed between the engine and the motor for executing an electric vehicle (EV) mode and an HEV mode, the system comprising:
a gear shift prediction unit configured to predict gear shift from a lower gear to a higher gear; and
a driving mode switching controller configured to decrease a switching reference value for driving mode switching from the EV mode to the HEV mode as a result of the gear shift prediction unit predicting that the gear shift is being performed from the lower gear to the higher gear.

2. The system of claim 1, further comprising:
an engine controller configured to perform fuel injection compensation control at a specific revolutions per minute (RPM) of the engine before the gear shift from the lower gear to the higher gear is completed during the driving mode switching from the EV mode to the HEV mode.

3. The system of claim 1, wherein the gear shift prediction unit is configured to predict gear shift between a start time of the engine and a time when the engine clutch is completely locked before the gear shift from a current gear to a higher gear is completed.

4. The system of claim 1, wherein the gear shift prediction unit is constituted by additionally setting a gear shift prediction line in a gear shift map of a transmission controller comprising torque requested by a driver and a vehicle speed.

5. A method of controlling switching between driving modes of a hybrid electric vehicle (HEV), the:
predicting, by a controller, gear shift from a lower gear to a higher gear;
decreasing, by the controller, a switching reference value for driving mode switching from an electric vehicle (EV) mode to an HEV mode to an arbitrary level in response to predicting the gear shift from the lower gear to the higher gear; and
performing, by the controller, fuel injection compensation control at a specific revolutions per minute (RPM) of an engine before the gear shift from the lower gear to the higher gear is completed during the driving mode switching from the EV mode to the HEV mode.

6. The method of claim 5, wherein a gear shift prediction line is additionally set in a gear shift map of a transmission controller comprising torque requested by a driver and a vehicle speed and, when a current driving operation point of the vehicle is a point after the gear shift prediction line and before an actual gear shift line, the gear shift is predict as being performed from the lower gear to the higher gear.

7. The method of claim 5, wherein the switching reference value for driving mode switching from the EV mode to the HEV mode is decreased to the arbitrary level by setting a second switching reference value that is less than a switching reference value before the decrease.

8. The method of claim 5, wherein the switching reference value for driving mode switching from the EV mode to the HEV mode is decreased to the arbitrary level by applying a factor less than 1 to a switching reference value before the decrease.

9. The method of claim 5, wherein when the gear shift from the lower gear to the higher gear is not predicted, the switching reference value for driving mode switching from the EV mode to the HEV mode is maintained at a switching reference value before the decrease.

10. The method of claim 5, wherein a fuel injection compensation amount at the lower gear is less than that at the higher gear.
